(19) United States
(12) Patent Application Publication
(10) Pub. No.: US 2004/0047981 A1
(43) Pub. Date: Mar. 11, 2004

(54) Method of producing display panel

(75) Inventors: Masaomi Ebe, Yamanashi (JP); Hiroyuki Mitomo, Yamanashi (JP)

Correspondence Address: SUGHRUE MION, PLLC, 2100 PENNSYLVANIA AVENUE, N.W., WASHINGTON, DC, 20037, US

(73) Assignee: PIONEER CORPORATION AND POINEER DISPLAY PRODUCTS CORPORATION

(21) Appl. No.: 10/649,721

(22) Filed: Aug. 28, 2003

(30) Foreign Application Priority Data
Aug. 30, 2002 (JP) P2002-255243

(51) Int. Cl. B05D 5/12; B05D 5/06

(52) U.S. Cl. 427/96; 427/162

(57) ABSTRACT

The steps of forming a panel includes a first step of forming a pattern-forming material layer having a predetermined pattern (bus-electrode material layer and BS material layer) on a substrate through an injection coating method such as an ink-jet method and a dispenser method, a second step of forming a dielectric-layer forming material layer in such a manner as to cover the pattern-forming material layer formed at the first step; and a third step of simultaneously calcining the pattern-forming material layer and the dielectric-layer forming material layer.

### CROSS REFERENCE OF RELATED APPLICATION

This application is based on and claims priority under 35 U.S.C. §119 with respect to Japanese Patent Application No. 2002-255243 filed on Aug. 30, 2002, the entire content of which is incorporated herein by reference.

### BACKGROUND OF THE INVENTION

The present invention relates to a method of producing a display panel such as a plasma display panel.

The structure of an ordinary plasma display panel (hereinafter called the PDP) as an example of a display panel which is referred in JP-A-11-149873 will be described as follows. FIG. 1 is an exploded perspective view of the internal structure of the PDP; and FIG. 2, a plan view of the structure of line electrode pairs 2 (X and Y) of the PDP by way of example.

As shown in FIG. 1, a plurality of line electrode pairs 2 (X and Y), a dielectric layer 3 for covering the line electrode pairs 2 (X and Y) and a protective layer 4 of MgO for covering the dielectric layer 3 are formed successively on the inner surface side of a front substrate 1 on a display surface side. Each line electrode pair 2 includes a transparent electrode 2a formed of a wide transparent conductive film of such as ITO and a metal electrode (bus electrode) 2b formed of a narrow metal film for use in supplementing the conductivity of the transparent electrode 2a.

On a glass back substrate 5 disposed opposite to the front substrate 1 via discharge spaces 8, there are formed column electrodes 6 disposed in a direction perpendicular to the line electrodes pairs 2 (X and Y) and used for forming a display cell at each intersection, belt like partition walls 9 for forming the sections of the discharge spaces 8 between the column electrodes 6 and 6, and phosphor layers of three primary colors 7R, 7G and 7B provided so as to cover the sides of the column electrodes 6 and the partition walls 9 against the discharge spaces 8. Rare gas is enclosed in the discharge spaces 8.

As shown in FIG. 2, each line electrode pair 2 (X and Y) corresponds to one line L of matrix display and the line electrode pairs are alternately arranged in a column direction in a manner adjacent to each other with a discharge gap G held therebetween with respect to each line L. In each line L, a section of display cell (discharge cell) is formed in a unit luminescent area E by the line electrode pair 2 (X and Y).

The operation of a display in the PDP will now be described.

First, a lighting cell (formed with an electrical wall charge) and a non-lighting cell (without an electrical wall charge) are selected through the address manipulation based on the selective discharge between the column electrode 6 and the line electrode pair 2 (X and Y) shown in FIG. 2. A discharge maintenance pulse is alternately applied to the line electrode pairs X and Y simultaneously over the whole line L after the address manipulation, whereby a surface discharge occurs each time the discharge maintenance pulse is applied in the light cell. The phosphor layers 7R, 7G and 7B are excited by ultraviolet rays due to the surface discharge, so that visible light is emitted.

Incidentally, photolithography has mainly been employed for forming the bus electrodes 2b when display panels such as PDPs are manufactured. In this case, the bus electrode has been formed by daubing photosensitive silver paste all over the substrate, exposing the paste to light via a mask having a predetermined pattern, developing and calcining the coating.

Further, photolithography has mainly been employed likewise for forming black stripe layers (BS layers) between the bus electrodes, that is, between display lines. In this case, black inorganic pigments are added to low-melting glass powder and the mixture is then mixed with photosensitive resin and a solvent to form photosensitive paste. Then the BS layers have been formed by daubing the photosensitive paste all over the substrate, exposing the paste to light via a mask having a predetermined pattern, developing and calcining the coating.

After the bus electrodes and the BS layers are formed, moreover, dielectric paste is uniformly applied to cover the bus electrodes and the BS layers and calcined to form the dielectric layer.

At the steps of forming the bus electrodes and the BS lagers up to forming the dielectric layer, calcination has been needed twice at least; however, the problem is that the calcination needed twice at the lowest results in complicating not only the processing step but also manufacturing facilities and moreover increasing the production cost.

Therefore, it is contemplated to calcine the bus electrodes or the BS layers and the dielectric layer simultaneously. However, wrinkles may appear in the upper dielectric layer when the bus electrodes or the BS layers and the dielectric layer are calcined simultaneously unless thermal properties of binders (resins) contained in materials for the upper dielectric layer and the bus electrodes or the BS layers as lower layers are properly matched.

As the binders are not satisfactorily removed from the lower bus electrode layer but allowed to remain together with a carbide, moreover, bubbling or hole defects are caused to appear. In addition, unremoved binder ingredients in the lower layers are trapped in the dielectric layer, which has proved to be a primary factor in the lowering of transmittance.

### SUMMARY OF THE INVENTION

An object of the invention made in consideration of the foregoing problems is to provide a method of producing a display panel manufacturable with greater efficiency while keeping up reliability.

In order to accomplish the above object, according to one aspect of the invention, there is provided a method of producing a display panel including a step of forming a panel having a pattern layer on a substrate and a dielectric layer for covering the pattern layer, the forming step including, a first step of forming a pattern-forming material layer having a predetermined pattern on the substrate through an injection coating method, a second step of forming a dielectric-layer forming material layer in such a manner as to cover the pattern-forming material layer formed at the first step, and a third step of simultaneously calcining the pattern-forming material layer and the dielectric-layer forming material layer.

In addition, according to a second aspect of the invention, there is provided a method of producing a display panel including a step of forming bus-electrode material layers for forming bus electrodes of two-layer structure having a black layer and a main conductive layer on transparent electrodes formed on a substrate, the forming step including, a first step of using a dispenser method for forming black material layers on the respective transparent electrodes and drying the black material layers, and a second step of using an ink-jet method for forming main conductive material layers on the respective black material layers.

### BRIEF DESCRIPTION OF THE DRAWINGS

These and other objects and advantages of this invention will become more fully apparent from the following detailed description taken with the accompanying drawings in which:

FIG. 1 is an exploded perspective view of the internal structure of an ordinary PDP;

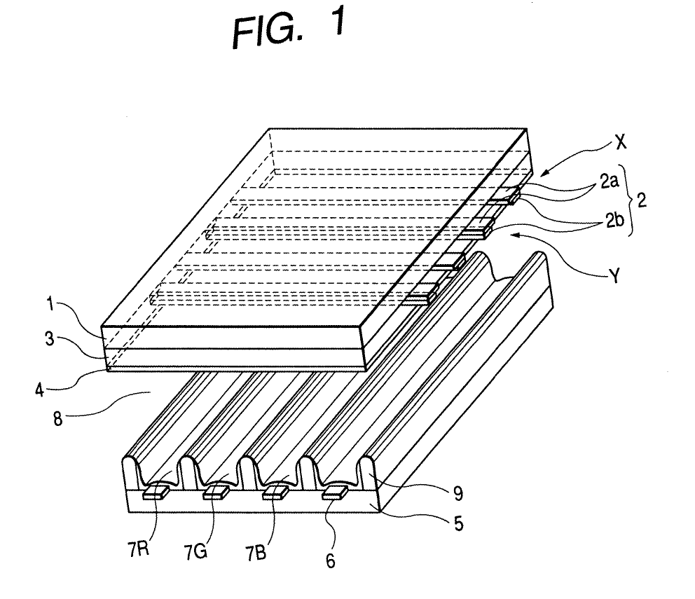

FIG. 2 is a plan view of the structure of line electrode pairs of the PDP of FIG. 1 by way of example;

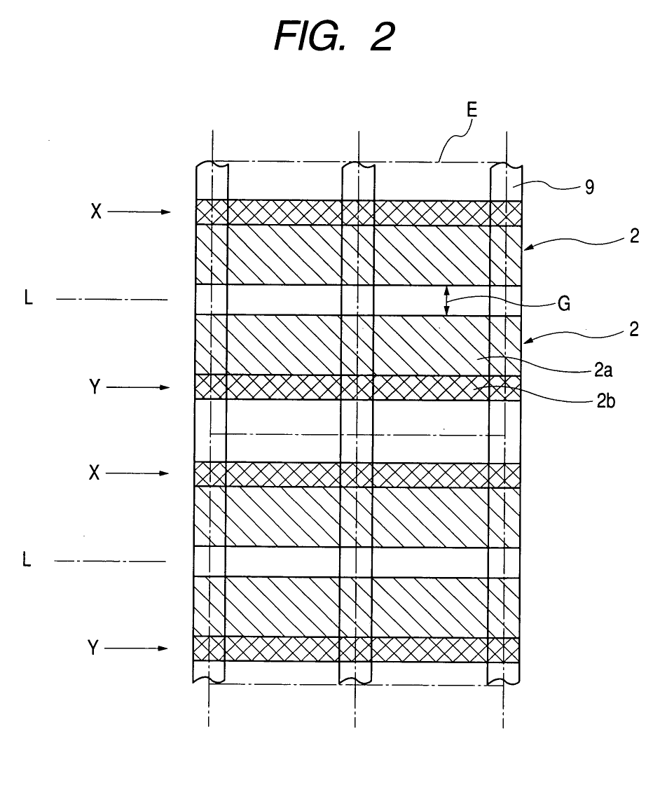

FIGS. 3A to 3C are exemplary sectional views illustrating the steps of forming a panel in a method of producing a display panel according to a first embodiment of the invention, Wherein FIG. 3A shows a first step, FIG. 3B shows a second step, and FIG. 3C shows a third step.

FIGS. 4A to 4C are exemplary sectional views illustrating the steps of forming a panel in a method of producing a display panel according to a second embodiment of the invention, wherein FIG. 4A shows a first step, FIGS. 4B shows a second step, and FIG. 4C shows a third step.

### DETAILED DESCRIPTION OF THE PREFERRED EMBODIMENTS

The embodiments of the invention will be described with reference to the drawings hereinafter.

First Embodiment

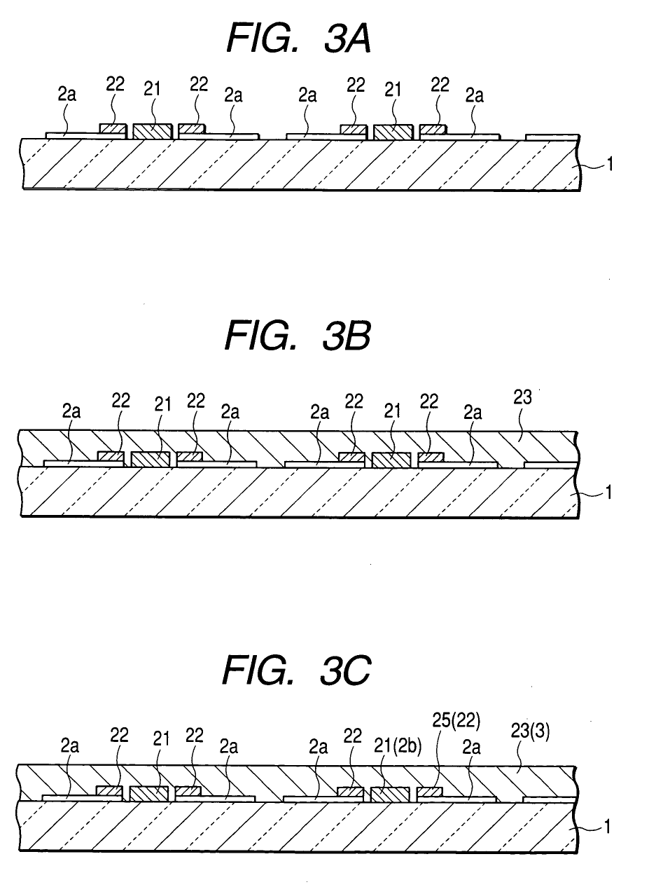

A method of producing a display panel according to a first embodiment of the invention will now be described by reference to FIGS. 3A to 3C. FIGS. 3A to 3C are exemplary sectional views illustrating the steps of forming a panel in the method of producing the display panel according to the first embodiment of the invention.

At the steps of forming the panel in the method of producing the display panel according to the first embodiment of the invention, an injection coating method such as an ink-jet method and a dispenser method is used at a first step as shown in FIG. 3A for forming a pattern-forming material layer having a predetermined pattern, namely, bus electrode material layers 22 and BS material layers 21 on a front substrate 1 where transparent electrodes 2a are formed. In this case, a mixed material containing silver powder, glass powder, resin and a solvent is used for the bus-electrode material layers 22, whereas a mixed material containing black inorganic pigments, glass powder, resin and a solvent is used for the BS material layers 21.

At a second step, as shown in FIG. 3B, the pattern-forming material layer (including the bus-electrode material layers 22 and the BS material layers 21) is coated (by printing) with a thick film of dielectric paste as a mixture of low-melting glass powder, resin and a solvent in such a manner as to cover the pattern-forming material layer or dielectric films are laminated to form a dielectric-layer forming layer 23.

At a third step, as shown in FIG. 3C, the pattern-forming material layer (including the bus-electrode material layers 22 and the BS material layers 21) and the dielectric-layer forming layer 23 are calcined simultaneously, whereby a panel is completed with the front substrate 1 on which the transparent electrodes 2a, bus electrodes 2b, BS material layers 25 and a dielectric layer 3 are piled up.

When the ink-jet method is used for forming the pattern-forming material layer according to this embodiment of the invention, any material can be applied to only a target location, so that utilization efficiency is increasable in comparison with the printing method.

Fine metal particles (several μm or less) are generally used for the electrode material intended for ink-jet printing and the smaller the particle size of the material, the finer the applied film becomes; consequently, shrinkage after burning quite common to the conventional material is hardly produced.

Further, a silver organic compound may also be used and in this case, organic matter can be decomposed at approximately hundred and tens of degrees and as a fine silver film can be left, the advantage is that problems arising from shrinkage after burning, removal of binders and so forth at the time of simultaneous calcination become preventable.

When the dispenser method is used for forming the pattern-forming material layer according to this embodiment of the invention, it is possible to discharge paste having a coefficient of viscosity lower than or equal to the paste in the printing method. Therefore, an amount of resin for use can be made smaller than the amount of resin in the case of printing paste and almost no problem is developed when the paste together with a dielectric is calcined.

As set forth above, according to this embodiment of the invention, a reduction in costs is achievable because the printing method causing a difficulty arising from maintaining precision and quality can be dispensed with.

Moreover it is advantageous in respect of manufacturing process and facilities that the number of calcining furnaces is reducible. As the photolithographic steps are unnecessary, the apparatus arrangement is simplified during the whole process and this results in curtailing energy consumption. Further, the advantage is that the quantity of waste material is reduced in comparison with the conventional method.

Second Embodiment

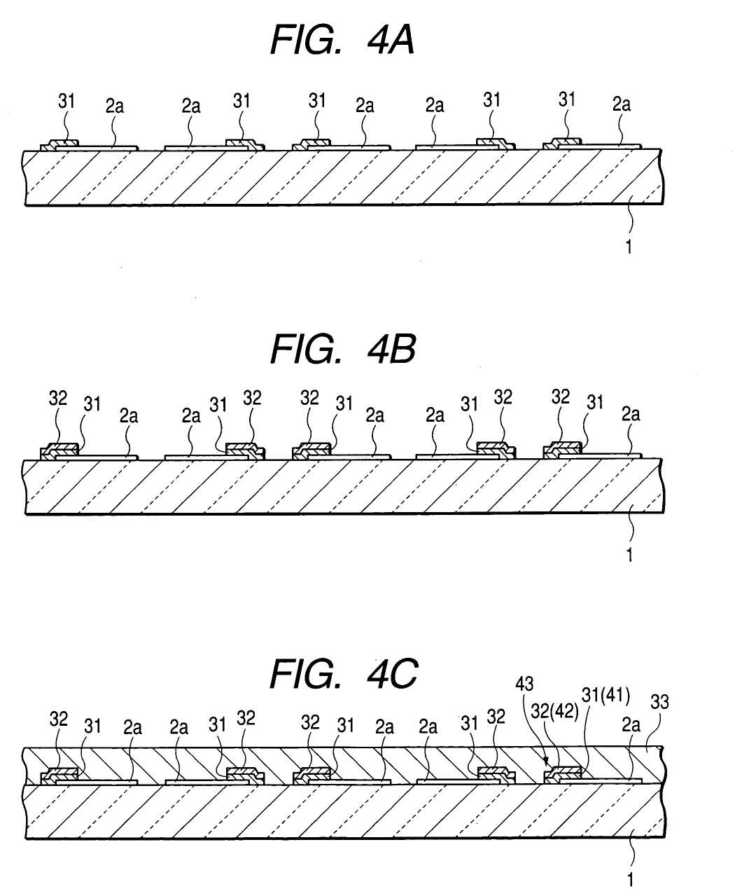

A method of producing a display panel according to a second embodiment of the invention will subsequently be described with reference to FIGS. 4A to 4C. FIGS. 4A to 4C are exemplary sectional views illustrating the steps of forming a panel in the method of producing the display panel according to the second embodiment of the invention.

The manufacturing method according to the second embodiment of the invention is to form bus electrodes of two-layer structure including a black layer and a main conductive layer with greater efficiency while keeping up reliability in that an attempt is made to increase efficiency by simultaneously calcining the black and main conductive layers together with a dielectric layer.

At the steps of forming the panel in the method of producing the display panel according to the second embodiment of the invention, the dispenser method is used at a first step as shown in FIG. 4A for forming black conductive material layers 31 on the respective transparent electrodes 2a on a substrate 1 and drying the black conductive material layers 31.

At a second step, as shown in FIG. 4B, the ink-jet method is used for forming main conductive material layers 32 on the respective black conductive material layers 31 and drying the main conductive material layers 32.

At a third step upon the termination of the step of forming these bus-electrode material layers, a dielectric material layer 33 is formed (the step of forming the dielectric material layer) as shown in FIG. 4C so as to cover the transparent electrodes 2a and the bus-electrode material layers (black conductive material layers 31 and the main conductive material layers 32). Then the bus-electrode material layers (the black conductive material layers 31 and the main conductive material layers 32) and the dielectric material layer 33 are simultaneously calcined (the calcination step).

With the steps of forming the panel above, bus electrodes 43 of two-layer structure including a black layer 41 and a main conductive layer 42 are formable with greater efficiency while reliability is maintained.

As the bus electrodes 43 are formed on the display surface side, the bus electrodes 43 have to be those which less reflect external light (e.g., black) seen from viewers. The black conductive material layers 31 are formed with Ag (silver) paste (hereinafter called the black Ag paste) with black inorganic pigments added, whereas the main conductive layers 42 are formed with Ag paste without the addition of the black inorganic pigments thereto (hereinafter called the while Ag paste).

According to this embodiment of the invention, the dispenser method is used for drawing straight lines with, for example, the black Ag paste and drying the paste. As the dispenser method allows paste having a high coefficient of viscosity to be discharged in comparison with the ink-jet method, a pattern can be formed while staining is being controlled by means of paste rheology adjustment like the patterning by the printing method.

When the black Ag paste is dried, the solvent part of the white Ag paste applied afterward is absorbed thereby, so that the bus electrodes 43 free from staining can be formed.

Although the Ag (silver) paste containing the black inorganic pigments (black conductive material) has been used to form the flack layers 41 by way of example, a black or dark-color material (black insulating material) without containing a conductive material of silver may be used for forming the black layers 41.

In this case, though an insulating layer (the black layer of the bus electrode) exists between the main conductive layer 42 of the bus electrode and the transparent electrode 2a, the conductive material of the main conductive material layer comes into the black material layer at the time of calcining the bus electrode material layer, so that the main conductive layers 42 and the transparent electrodes 2a conduct. When the black layers 41 of the bus electrodes are formed with the black insulating material, the dispenser method may be used for simultaneously forming the BS layers (black stripe layers) made of the same material and simultaneously calcining the bus-electrode material layers and the dielectric material layer.

What is claimed is:

1. A method of producing a display panel including a step of forming a panel having a pattern layer on a substrate and a dielectric layer for covering the pattern layer, the forming step comprising:
a first step of forming a pattern-forming material layer having a predetermined pattern on the substrate through an injection coating method;
a second step of forming a dielectric-layer forming material layer in such a manner as to cover the pattern-forming material layer formed at the first step; and
a third step of simultaneously calcining the pattern-forming material layer and the dielectric-layer forming material layer

2. A method of producing a display panel according to claim 1, wherein
the pattern-forming material layer contains silver, resin and glass powder.

3. A method of producing a display panel according to claim 1, wherein
the pattern-forming material layer includes black inorganic pigments, resin and glass powder.

4. A method of producing a display panel according to claims 1, wherein
the injection coating method is an ink-jet method.

5. A method of producing a display panel according to claims 1, wherein the injection coating method is a dispenser method.

6. A method of producing a display panel including a step of forming bus-electrode material layers for forming bus electrodes of two-layer structure having a black layer and a main conductive layer on transparent electrodes formed on a substrate, the forming step comprising:
a first step of using a dispenser method for forming black material layers on the respective transparent electrodes and drying the black material layers; and
a second step of using an ink-jet method for forming main conductive material layers on the respective black material layers.

7. A method of producing a display panel according to claim 6, further comprising the steps of:
forming a dielectric material layer so as to cover the transparent electrodes and the bus-electrode material layers; and
simultaneously calcining the bus-electrode material layers and the dielectric material layer.
